(19) United States
(12) Patent Application Publication
(10) Pub. No.: US 2026/0195854 A1
(43) Pub. Date: Jul. 9, 2026

(54) IMAGE PROCESSING METHOD, SYSTEM AND APPARATUS, ELECTRONIC DEVICE, AND READABLE STORAGE MEDIUM

(71) Applicant: VIVO MOBILE COMMUNICATION CO., LTD., Dongguan (CN)

(72) Inventors: Xiaofei LI, Dongguan (CN); Jin ZHANG, Dongguan (CN)

(73) Assignee: VIVO MOBILE COMMUNICATION CO., LTD., Dongguan (CN)

(21) Appl. No.: 19/551,614

(22) Filed: Feb. 27, 2026

Related U.S. Application Data
(63) Continuation of application No. PCT/CN2024/114596, filed on Aug. 26, 2024.

(30) Foreign Application Priority Data
Aug. 30, 2023 (CN) 202311113036.6

(51) Int. Cl. G06T 3/4046; G06T 3/4023

(52) U.S. Cl. CPC G06T 3/4046; G06T 3/4023

(57) ABSTRACT

An image processing method, an image processing system, an image processing apparatus, an electronic device, and a non-transitory computer-readable storage medium are provided. The image processing method includes: calculating first data based on at least one padding pixel in an input image, a coefficient in one convolution kernel and in one-to-one correspondence with the at least one padding pixel, or an output bias corresponding to the one convolution kernel. The input image is an input image of a deconvolution layer in a neural network model. The image processing method further includes calculating second data based on at least one non-padding pixel in the input image or a coefficient in the one convolution kernel and in one-to-one correspondence with the at least one non-padding pixel. The image processing method also includes calculating a pixel value of one output pixel based on the first data and the second data.

### CROSS-REFERENCE TO RELATED APPLICATIONS

This application is a continuation of International Application No. PCT/CN 2024/114596, filed on Aug. 26, 2024, which claims priority to Chinese Patent Application No. 202311113036.6, filed on Aug. 30, 2023. The entire contents of each of the above-referenced applications are expressly incorporated herein by reference.

### TECHNICAL FIELD

This application pertains to the technical field of electronic devices, and specifically relates to an image processing method, system, and apparatus, an electronic device, and a readable storage medium.

### BACKGROUND

At present, for operations of a deconvolution layer in a convolutional neural network model, typically an asymmetric quantization method is first used to quantize the convolutional neural network model so as to convert floating-point numbers into fixed-point numbers. This quantization processing changes pixel values of padding pixels in an input image from 0 to non-zero. Then, zero-point offset processing is performed on each pixel of the quantized input image so that the pixel values of the padding pixels stay at 0, thereby reducing a computational load of subsequent convolution operations.

However, because of the high parallelism of operations in the convolutional neural network model and the usually large bandwidth of the input image, a large number of subtractors and registers are required for the zero-point offset processing, resulting in relatively large occupied area and high power consumption of hardware.

### SUMMARY

Embodiments of this application are intended to provide an image processing method, system, and apparatus, an electronic device, and a readable storage medium.

According to a first aspect, an embodiment of this application provides an image processing method. The method includes: calculating first data based on at least one padding pixel in an input image, a coefficient in one convolution kernel and in one-to-one correspondence with the at least one padding pixel, and an output bias corresponding to the one convolution kernel, where the input image is an input image of a deconvolution layer in a neural network model; calculating second data based on at least one non-padding pixel in the input image and a coefficient in the one convolution kernel and in one-to-one correspondence with the at least one non-padding pixel; and calculating a pixel value of one output pixel based on the first data and the second data.

According to a second aspect, an embodiment of this application provides an image processing system. The system includes a first chip and a second chip that are different from each other, and the second chip is a chip dedicated to computation of a neural network model; where the first chip is configured to calculate first data based on at least one padding pixel in an input image, a coefficient in one convolution kernel and in one-to-one correspondence with the at least one padding pixel, and an output bias corresponding to the one convolution kernel, where the input image is an input image of a deconvolution layer in the neural network model; the second chip is configured to calculate second data based on at least one non-padding pixel in the input image and a coefficient in the one convolution kernel and in one-to-one correspondence with the at least one non-padding pixel; and the second chip is further configured to calculate a pixel value of one output pixel based on the first data and the second data.

According to a third aspect, an embodiment of this application provides an image processing apparatus. The apparatus includes a calculation module; where the calculation module is configured to calculate first data based on at least one padding pixel in an input image, a coefficient in one convolution kernel and in one-to-one correspondence with the at least one padding pixel, and an output bias corresponding to the one convolution kernel, where the input image is an input image of a deconvolution layer in a neural network model; the calculation module is further configured to calculate second data based on at least one non-padding pixel in the input image and a coefficient in the one convolution kernel and in one-to-one correspondence with the at least one non-padding pixel; and the calculation module is further configured to calculate a pixel value of one output pixel based on the first data and the second data.

According to a fourth aspect, an embodiment of this application provides an electronic device. The electronic device includes a processor and a memory, where the memory stores a program or instructions capable of running on the processor, and when the program or instructions are executed by the processor, the steps of the method according to the first aspect are implemented.

According to a fifth aspect, an embodiment of this application provides a readable storage medium. The readable storage medium stores a program or instructions, and when the program or instructions are executed by a processor, the steps of the method according to the first aspect are implemented.

According to a sixth aspect, an embodiment of this application provides a chip. The chip includes a processor and a communication interface, where the communication interface is coupled to the processor, and the processor is configured to run a program or instructions to implement the method according to the first aspect.

According to a seventh aspect, an embodiment of this application provides a computer program product. The program product is stored in a storage medium, and the program product is executed by at least one processor to implement the method according to the first aspect.

In the embodiments of this application, first data may be calculated based on at least one padding pixel in an input image, a coefficient in one convolution kernel and in one-to-one correspondence with the at least one padding pixel, and an output bias corresponding to the one convolution kernel, where the input image is an input image of a deconvolution layer in a neural network model; second data may be calculated based on at least one non-padding pixel in the input image and a coefficient in the one convolution kernel and in one-to-one correspondence with the at least one non-padding pixel; and a pixel value of one output pixel may be calculated based on the first data and the second data. With this solution, in the operation process of the deconvolution layer, a pixel value of an output pixel can be calculated based merely on the pixels in the input image and the convolution kernel, without requiring zero-point offset processing on each pixel of the input image throughout the operation process. This eliminates the need for numerous subtractors and registers, thereby reducing the occupied area and power consumption of hardware.

### BRIEF DESCRIPTION OF DRAWINGS

FIG. 1 is a schematic diagram of an operation principle of a deconvolution layer in the related art;

FIG. 2 is a first flowchart of an image processing method according to an embodiment of this application;

FIG. 3 is a second flowchart of an image processing method according to an embodiment of this application;

FIG. 4 is a third flowchart of an image processing method according to an embodiment of this application;

FIG. 5 is a fourth flowchart of an image processing method according to an embodiment of this application;

FIG. 6 is a first schematic diagram of an image processing method according to an embodiment of this application;

FIG. 7 is a second schematic diagram of an image processing method according to an embodiment of this application;

FIG. 8 is a third schematic diagram of an image processing method according to an embodiment of this application;

FIG. 9 is a fourth schematic diagram of an image processing method according to an embodiment of this application;

FIG. 10 is a fifth schematic diagram of an image processing method according to an embodiment of this application;

FIG. 11 is a sixth schematic diagram of an image processing method according to an embodiment of this application;

FIG. 12 is a schematic diagram of an image processing system according to an embodiment of this application;

FIG. 13 is a schematic diagram of an image processing apparatus according to an embodiment of this application;

FIG. 14 is a schematic diagram of an electronic device according to an embodiment of this application; and

FIG. 15 is a schematic hardware diagram of an electronic device according to an embodiment of this application.

### DETAILED DESCRIPTION

The following describes the technical solutions in the embodiments of this application clearly with reference to the accompanying drawings in the embodiments of this application. Apparently, the described embodiments are some but not all of the embodiments of this application. All other embodiments obtained by persons of ordinary skill in the art based on the embodiments of this application fall within the protection scope of this application.

The terms “first”, “second”, and the like in this specification and claims of this application are used to distinguish between similar objects rather than to describe a specific order or sequence. It should be understood that data used in this way are interchangeable in appropriate circumstances such that the embodiments of this application can be implemented in other orders than the order illustrated or described herein. In addition, objects distinguished by “first” and “second” are generally of a same type, and the quantities of the objects are not limited, for example, there may be one or more first objects. In addition, “and/or” in the specification and claims represents at least one of connected objects, and the character “/” generally indicates that the associated objects have an “or” relationship.

The term “indication” in this application may be a direct indication (or explicit indication) or an indirect indication (or implicit indication). A direct indication may be understood as a sender explicitly informing a receiver of content such as information, an operation to be performed, or a request result in a sent indication; an indirect indication may be understood as a receiver determining corresponding information based on an indication sent by a sender, or making a judgment and determining an operation to be performed, a request result, or the like based on a judgment result.

The terms “at least one (item)”, “at least one of”, and the like in the specification and claims of this application refer to any one, any two, or a combination of two or more of the contained objects. For example, at least one (item) of a, b, and c may represent: “a”, “b”, “c”, “a and b”, “a and c”, “b and c”, and “a, b and c”, where a, b, and c each may be provided in a quantity of one or more. Similarly, “at least two (items)” means two or more, and its meaning is similar to that of “at least one (item)”.

The following describes an image processing method, system, and apparatus, an electronic device, and a readable storage medium according to the embodiments of this application in detail through embodiments and application scenarios thereof with reference to the accompanying drawings.

With the continuous development and advancement of artificial intelligence technology, a multitude of neural network models have emerged, demonstrating broad application prospects in fields such as system identification, pattern recognition, and intelligent control. However, the implementation of these neural network models requires strong computing power support. Currently, Application Specific Integrated Circuit (ASIC) chips dedicated to neural network model computation are widely used to implement these neural network models.

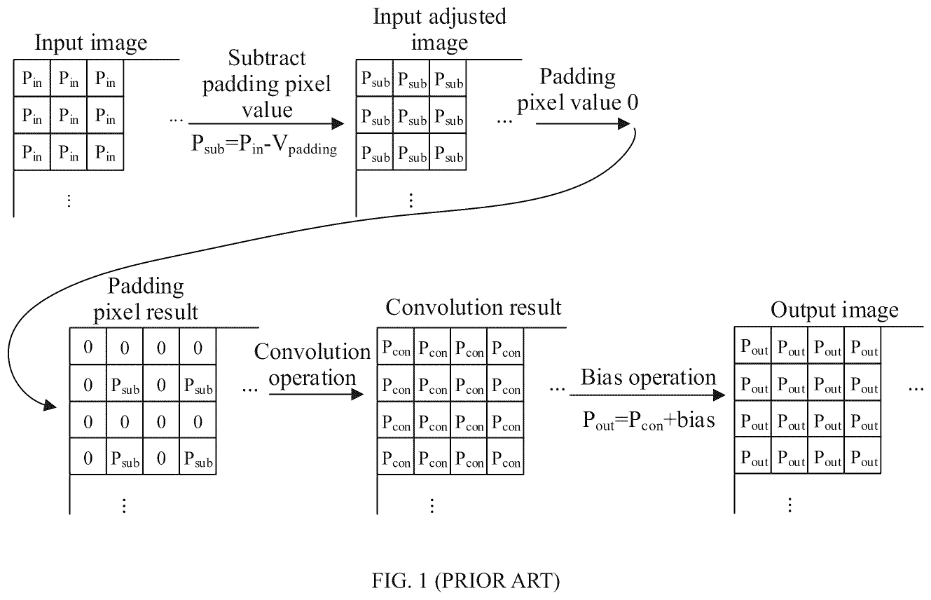

At present, as one of the neural network models, a convolutional neural network model typically includes hierarchical structures with a large amount of computation, such as a convolution layer, a pooling layer, and a deconvolution layer. As shown in FIG. 1, an operation principle of the deconvolution layer is as follows: First, numerous padding pixels with a pixel value of 0 are inserted between every two adjacent pixels of an input image (that is, padding), and then convolution calculation is performed on each pixel in the input image with the padding pixels inserted, so as to increase the size of an output image. In terms of hardware implementation, in order to reduce the computational load of the customized ASIC chip, the convolutional neural network model is typically quantized first to convert floating-point numbers into fixed-point numbers, where asymmetric quantization is one of the commonly used quantization processing methods, but this quantization processing causes the pixel values of the padding pixels to change from 0 to non-zero; then, zero-point offset (that is, subtracting zero-point) processing is performed on each pixel of the quantized input image. For the deconvolution layer, the zero-point is a non-zero value obtained after quantization of the value 0 of the original image pixels (that is, non-padding pixels) of the input image, so that the pixel values of the padding pixels subsequently inserted between pixels become 0, thereby reducing the computational load of convolution operations.

However, according to the above method, although the zero-point offset processing in asymmetric quantization can greatly reduce the computational load of subsequent convolution operations, due to the high parallelism of operations in the convolutional neural network model and the usually large bandwidth of the input image, a large number of subtractors and registers are required for the zero-point offset processing, resulting in relatively large occupied area and high power consumption of the customized ASIC chip.

The embodiments of this application provide an image processing method, system, and apparatus, an electronic device, and a readable storage medium. The image processing method provided in the embodiments of this application can be applied to the operation process of a deconvolution layer of a convolutional neural network model.

In the image processing method provided in the embodiments of this application, first data may be calculated based on at least one padding pixel in an input image, a coefficient in one convolution kernel and in one-to-one correspondence with the at least one padding pixel, and an output bias corresponding to the one convolution kernel, where the input image is an input image of a deconvolution layer in a neural network model; second data may be calculated based on at least one non-padding pixel in the input image and a coefficient in the one convolution kernel and in one-to-one correspondence with the at least one non-padding pixel; and a pixel value of one output pixel may be calculated based on the first data and the second data. With this solution, in the operation process of the deconvolution layer, a pixel value of an output pixel can be calculated based merely on the pixels in the input image and the convolution kernel, without requiring zero-point offset processing on each pixel of the input image throughout the operation process. This eliminates the need for numerous subtractors and registers, thereby reducing the occupied area and power consumption of the customized ASIC chip.

It should be noted that the image processing method provided in the embodiments of this application may be performed by an image processing apparatus, an electronic device, a functional module in an electronic device, or the like. In some embodiments of this application, the image processing method being executed by an electronic device is used as an example to illustrate the image processing method provided in the embodiments of this application.

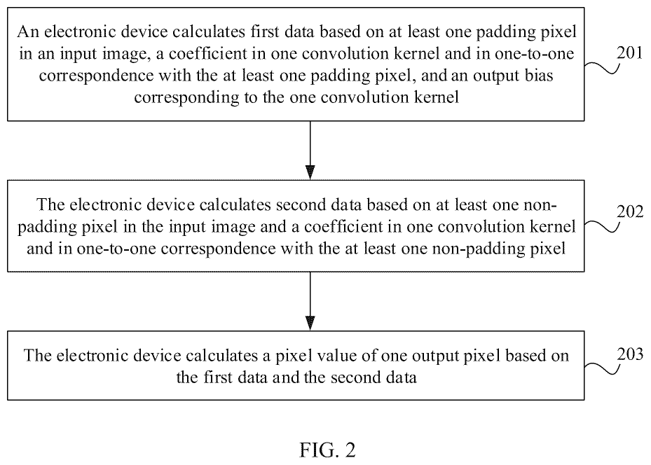

FIG. 2 is a flowchart of an image processing method according to an embodiment of this application. As shown in FIG. 2, the image processing method provided in the embodiment of this application may include the following steps 201 to 203.

Step 201: An electronic device calculates first data based on at least one padding pixel in an input image, a coefficient in one convolution kernel and in one-to-one correspondence with the at least one padding pixel, and an output bias corresponding to the one convolution kernel.

The input image is an input image of a deconvolution layer in a neural network model.

In some embodiments of this application, the neural network model may be a convolutional neural network model.

In some embodiments of this application, the input image may be a multi-channel input image.

In some embodiments of this application, the one convolution kernel has the same number of channels as the input image.

In some embodiments of this application, all coefficients in the one convolution kernel are obtained during training of the neural network model.

In some embodiments of this application, one or more convolution kernels may be used in the entire operation process of the deconvolution layer.

It should be noted that the output bias is a learnable parameter in the convolutional neural network model. The output bias can be trained like a weight. The output bias is typically a single value, and each convolution kernel has only one corresponding output bias. The output bias can be used to eliminate the linearity of the output of a convolution layer, making the convolutional neural network model more robust, and improving the performance of the convolution layer.

In some embodiments of this application, one padding pixel is a pixel inserted between two original image pixels (that is, the non-padding pixels described below) of the input image.

In some embodiments of this application, the electronic device may calculate the first data through a first chip based on the at least one padding pixel, the coefficient in the one convolution kernel and in one-to-one correspondence with the at least one padding pixel, and the output bias corresponding to the one convolution kernel.

In some embodiments of this application, the first chip may be any chip in the electronic device other than a chip dedicated to neural network model computation, such as a Central Processing Unit (CPU) or a Microcontroller Unit (MCU).

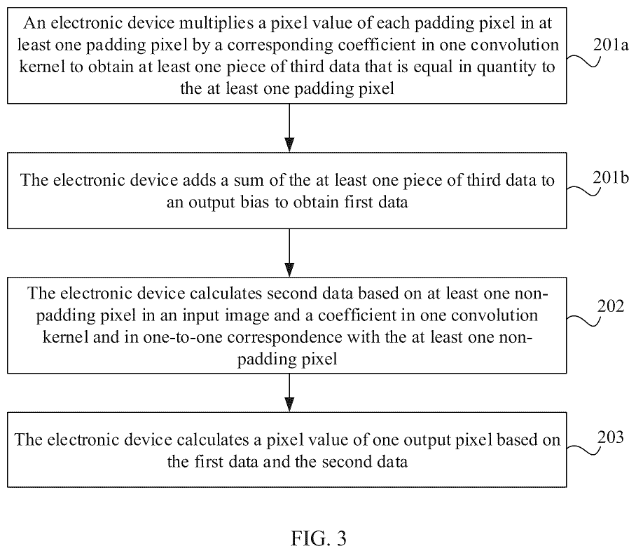

In some embodiments of this application, with reference to FIG. 2, as shown in FIG. 3, the foregoing step 201 may be implemented by the following step 201a and step 201b.

Step 201a: The electronic device multiplies a pixel value of each padding pixel in the at least one padding pixel by a corresponding coefficient in the one convolution kernel to obtain at least one piece of third data that is equal in quantity to the at least one padding pixel.

In some embodiments of this application, each padding pixel has a one-to-one corresponding coefficient in the one convolution kernel, and the electronic device may multiply the pixel value of each padding pixel by the one-to-one corresponding coefficient to obtain the at least one piece of third data.

For example, it is assumed that the at least one padding pixel includes pixel 1, pixel 2, pixel 3, and pixel 4, the coefficient corresponding to pixel 1 in the one convolution kernel is coefficient a, the coefficient corresponding to pixel 2 in the one convolution kernel is coefficient b, the coefficient corresponding to pixel 3 in the one convolution kernel is coefficient c, and the coefficient corresponding to pixel 4 in the one convolution kernel is coefficient d. Then, the electronic device may multiply the pixel value of pixel 1 by coefficient a to obtain data A, multiply the pixel value of pixel 2 by coefficient b to obtain data B, multiply the pixel value of pixel 3 by coefficient c to obtain data C, and multiply the pixel value of pixel 4 by coefficient d to obtain data D, respectively. It can be seen that the electronic device obtains four pieces of data, namely data A, data B, data C, and data D (that is, the at least one piece of third data), and a quantity of the obtained data is equal to a quantity of the at least one padding pixel.

Step 201b: The electronic device adds a sum of the at least one piece of third data to the output bias to obtain the first data.

In some embodiments of this application, the electronic device may first add up the at least one piece of third data to obtain a sum of the at least one piece of third data, and then add the sum of the at least one piece of third data to the output bias to obtain the first data.

It should be noted that the pixel value of each padding pixel and the coefficient in the one convolution kernel are both parameters related to the neural network model, so that the electronic device can be controlled by software to perform the foregoing step 201a and step 201b through the first chip.

In the embodiments of this application, since the electronic device can add the multiply-accumulate result of the pixel value of each padding pixel and the corresponding coefficient in the one convolution kernel to the output bias to obtain the first data, the operation of the padding pixel part can be completed without zero-point offset processing. In this way, no additional subtractors and registers need to be added, thereby reducing the design area of hardware.

Step 202: The electronic device calculates second data based on at least one non-padding pixel in the input image and a coefficient in the one convolution kernel and in one-to-one correspondence with the at least one non-padding pixel.

In some embodiments of this application, the non-padding pixel is an original image pixel in the input image.

In some embodiments of this application, each non-padding pixel in the at least one non-padding pixel has a corresponding coefficient in the one convolution kernel.

In some embodiments of this application, the electronic device may calculate the second data through a second chip based on the at least one non-padding pixel and the coefficient in the one convolution kernel and in one-to-one correspondence with the at least one non-padding pixel.

In the embodiments of this application, the second chip is different from the first chip.

In some embodiments of this application, the second chip may be a chip dedicated to computation of the neural network model. For example, the second chip is a customized ASIC chip dedicated to computation of the neural network model.

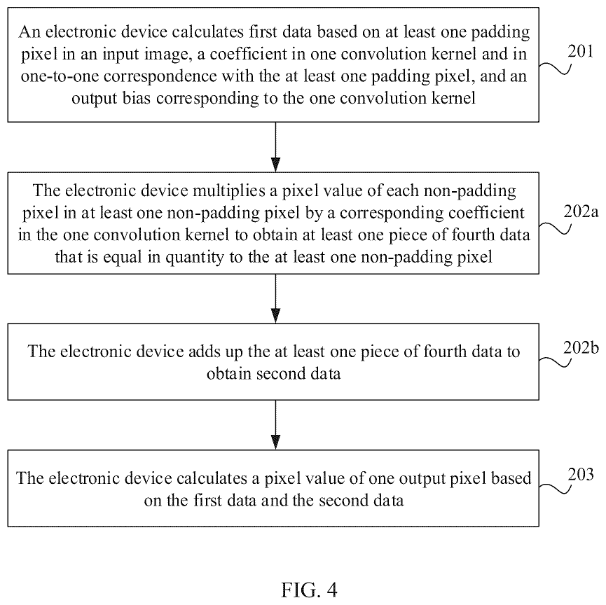

In some embodiments of this application, with reference to FIG. 2, as shown in FIG. 4, the foregoing step 202 may be implemented by the following step 202a and step 202b.

Step 202a: The electronic device multiplies a pixel value of each non-padding pixel in the at least one non-padding pixel by a corresponding coefficient in the one convolution kernel to obtain at least one piece of fourth data that is equal in quantity to the at least one non-padding pixel.

Step 202b: The electronic device adds up the at least one piece of fourth data to obtain the second data.

For the description in the embodiments of this application, reference may be made to the relevant description in the foregoing step 201a and step 201b. To avoid repetition, details are not described herein again.

In the embodiments of this application, since the electronic device can use the multiply-accumulate result of the pixel value of each non-padding pixel and the corresponding coefficient in the one convolution kernel as the second data, the operation of the non-padding pixel part can be completed without zero-point offset processing. This eliminates the need for numerous subtractors and registers, thereby reducing the design area of hardware.

Step 203: The electronic device calculates a pixel value of one output pixel based on the first data and the second data.

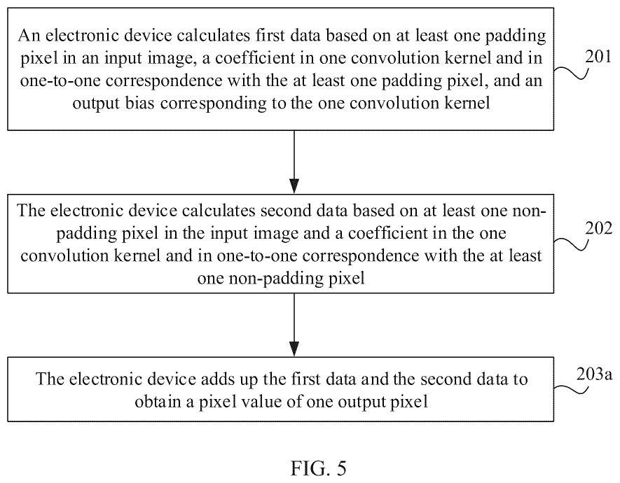

In some embodiments of this application, with reference to FIG. 2, as shown in FIG. 5, the foregoing step 203 may be implemented by the following step 203a.

Step 203a: The electronic device adds up the first data and the second data to obtain the pixel value of the one output pixel.

In some embodiments of this application, the electronic device may add up the first data and the second data through the second chip to obtain the pixel value of the one output pixel.

In some embodiments of this application, after obtaining the first data through the first chip, the electronic device may configure the first data to a storage unit in the second chip through bus configuration. In this way, after acquiring the first data and calculating the second data, the second chip may add up the first data and the second data to obtain the pixel value of the one output pixel.

In the embodiments of this application, since the electronic device can add up the first data and the second data to obtain the pixel value of the one output pixel, the entire operation of the deconvolution layer can be completed without zero-point offset processing. In this way, no additional subtractors and registers need to be added, thereby reducing the design area and power consumption of hardware.

The following describes the image processing method provided in the embodiments of this application with reference to the accompanying drawings.

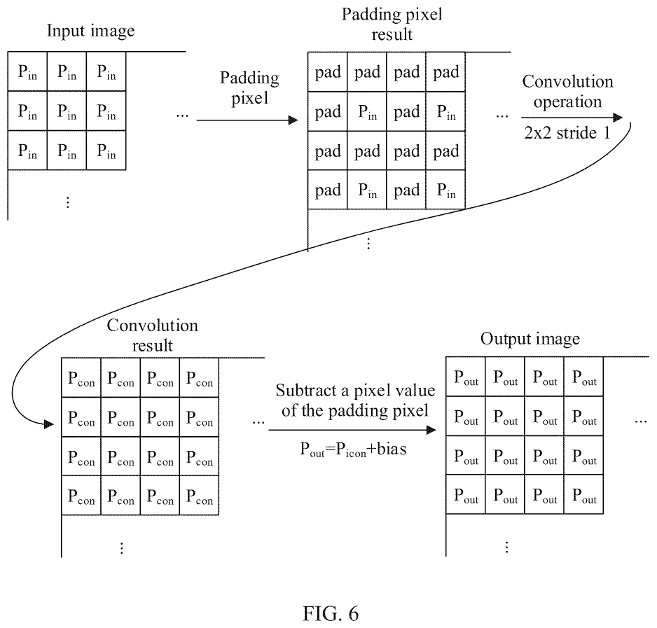

For example, it is assumed that the one convolution kernel is a 2×2 convolution kernel and the deconvolution stride of the deconvolution layer is 2. Then, as shown in FIG. 6, the electronic device may first insert one padding pixel between every two adjacent pixels of the input image, then perform a convolution operation with a convolution kernel of 2×2 and a convolution stride of 1 on the padded input image, and finally add an output bias to each pixel obtained after the convolution to obtain a final output result of the deconvolution layer.

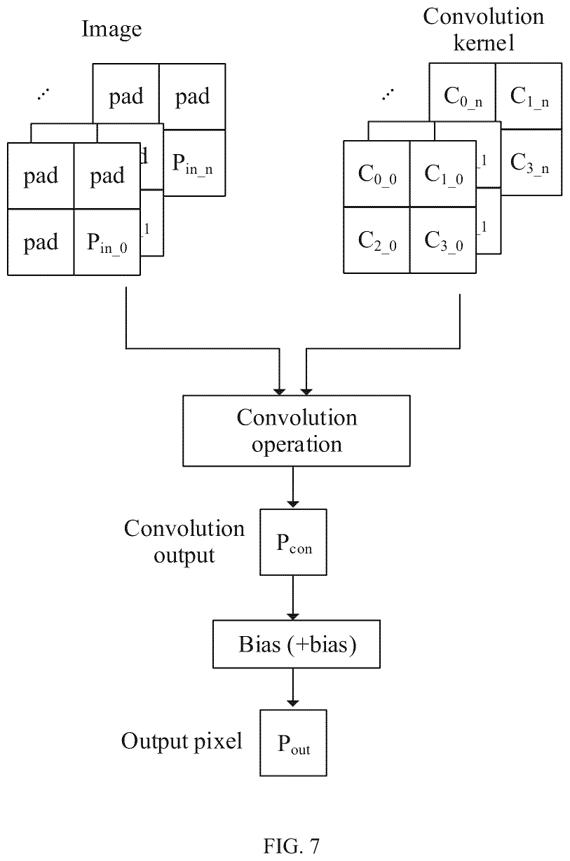

For example, as shown in FIG. 7, since the size of the one convolution kernel is 2×2, each convolution operation requires participation of a 2×2 image window. In the input image, there is one padding pixel pad between every two input pixels Pᵢₙ (that is, the non-padding pixels). Therefore, this 2×2 image window contains one input pixel Pᵢₙ and three padding pixels pad. Pixels (pad or Pᵢₙ) at corresponding positions and coefficients (C) in the one convolution kernel are subjected to multiply-accumulate operation to obtain a convolution result P_{con}, and then the obtained convolution result P_{con} is added to an output bias corresponding to the one convolution kernel to obtain a pixel value Pₒᵤₜ of one output pixel of the deconvolution layer. Pₒᵤₜ can be calculated according to the following formula (1):

$${P}_{out} = pad \times ( {C}_{0 \_ 0} + {C}_{0 \_ 1} + … + {C}_{0 \_ n} + {C}_{1 \_ 0} + {C}_{1 \_ 1} + … + {C}_{1 \_n} + {C}_{2 \_ 0} + {C}_{2 \_ 1} + … + {C}_{2 \_ n} ) + ( {P}_{in\_ 0} \times {C}_{3 \_ 0} + {P}_{in\_ 1} \times {C}_{3 \_ 1} + … + {P}_{in \_ n} \times {C}_{3 \_ n} ) + bias \qquad ( 1 )$$

It can be seen that the first term and the third term in the foregoing formula (1) are composed entirely of parameters (padding pixels and convolution kernel coefficients) of the neural network model. Therefore, in the image processing method provided in the embodiments of this application, these terms can be pre-calculated in advance by software control through the first chip, and then a result of adding up the two terms is written into the second chip as a new output bias bias_new.

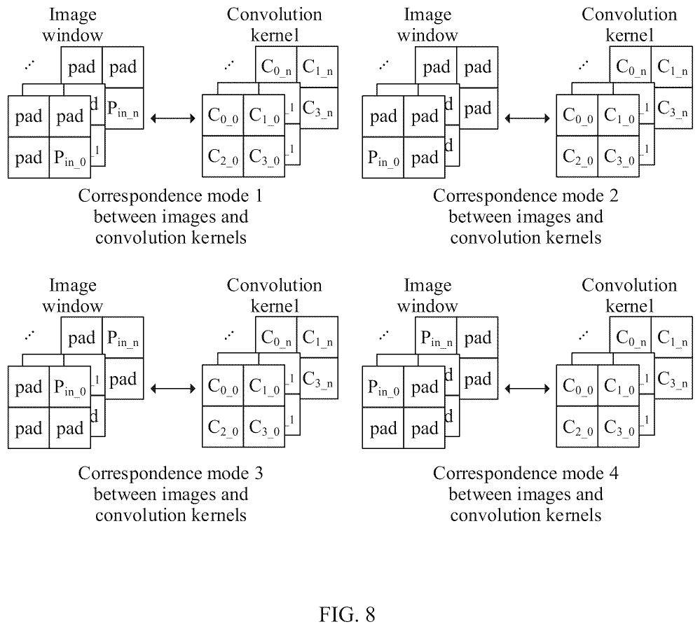

In the convolution operation, since the image selection window for the convolution operation with a stride of 1 slides on the padded input image, there are four correspondence modes between image pixels and convolution kernel coefficients in total. FIG. 8 shows the correspondence relationships in the four correspondence modes. Thus, for each convolution kernel, there are also four new output biases that can be pre-calculated by software control through the first chip, which are respectively:

$$bias\_new 0 = pad \times ( {C}_{0 \_ 0} + {C}_{0 \_ 1} + … + {C}_{0 \_ n} + {C}_{1 \_ 0} + {C}_{1 \_ 1} + … + {C}_{1 \_ n} + {C}_{2 \_ 0} + {C}_{2 \_ 1} + … + {C}_{2 \_n} ) + bias ; \\ bias\_new 1 = pad \times ( {C}_{0 \_ 0} + {C}_{0 \_ 1} + … + {C}_{0 \_ n} + {C}_{1 \_ 0} + {C}_{1 \_ 1} + … + {C}_{1 \_ n} + {C}_{3 \_ 0} + {C}_{3 \_ 1} + … + {C}_{3 \_ n} ) + bias ; \\ bias\_new2 = pad \times ( {C}_{0 \_ 0} + {C}_{0 \_ 1} + … + {C}_{0 \_ n} + {C}_{2 \_ 0} + {C}_{2 \_ 1} + … + {C}_{2 \_ n} + {C}_{3 \_ 0} + {C}_{3 \_ 1} + … + {C}_{3 \_ n} ) + bias ; \\ and bias\_new3 = pad \times ( {C}_{1 \_ 0} + {C}_{1 \_ 1} + … + {C}_{1 \_ n} + {C}_{2 \_ 0} + {C}_{2 \_ 1} + … + {C}_{2 \_ n} + {C}_{3 \_ 0} + {C}_{3 \_ 1} + … + {C}_{3 \_ n} ) + bias .$$

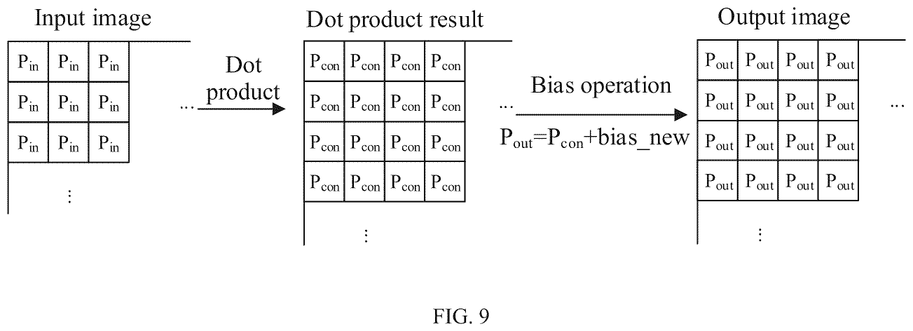

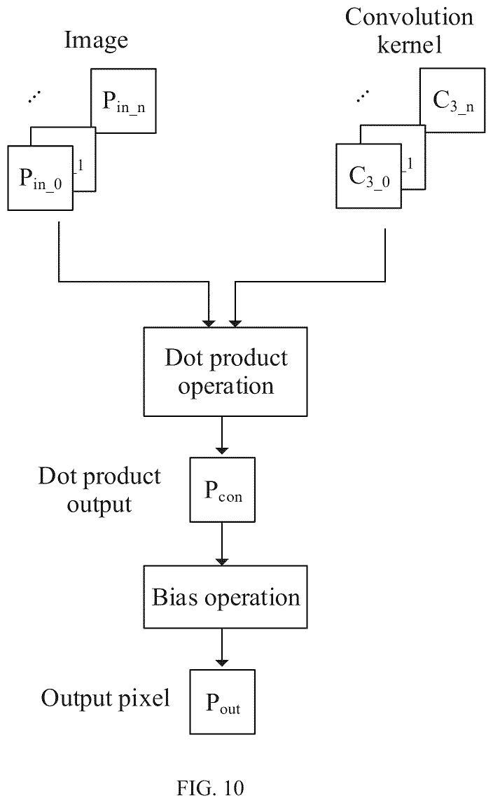

The calculation process is shown in FIG. 9. Since the operation involving the padding pixel part is completed by software control through the first chip, the second chip only needs to complete the multiply-accumulate operation of the original input image pixels and the convolution kernel coefficients, and then add the result to the new output bias bias_new. FIG. 10 shows a calculation process of one output result Pₒᵤₜ, where the calculation formula of the deconvolution layer is as shown in the following formula (2):

$${P}_{out} = ( {P}_{in\_ 0} \times {C}_{{3}_{-} 0} + {P}_{in\_ 1} \times {C}_{{3}_{-} 1} + {P}_{in \_ n} \times {C}_{3 \_ n} ) + bias\_new \qquad ( 2 )$$

Similarly, due to the sliding of the image selection window in the convolution operation process, each input image pixel has four correspondence modes with the coefficients of the convolution kernel, that is, pixel values of four image pixels can be output, which are respectively:

$${P}_{out 0} = ( {P}_{in \_ 0} \times {C}_{3 \_ 0} + {P}_{in \_ 1} \times {C}_{3 \_ 1} + … + {P}_{in \_ n} \times {C}_{3 \_ n} ) + bias\_new 0 ; \\ {P}_{out 1} = ( {P}_{in \_ 0} \times {C}_{2 \_ 0} + {P}_{in \_ 1} \times {C}_{2 \_ 1} + … + {P}_{in \_ n} \times {C}_{2 \_n} ) + bias\_new 1 ; \\ {P}_{out 2} = ( {P}_{in \_ 0} \times {C}_{1 \_ 0} + {P}_{in \_ 1} \times {C}_{1 \_ 1} + … + {P}_{in \_ n} \times {C}_{1 \_n} ) + bias\_new 2 ; \\ {P}_{out 3} = ( {P}_{in \_ 0} \times {C}_{0 \_ 0} + {P}_{in \_ 1} \times {C}_{0 \_ 1} + … + {P}_{in \_ n} \times {C}_{0 \_ n} ) + bias\_new 3.$$

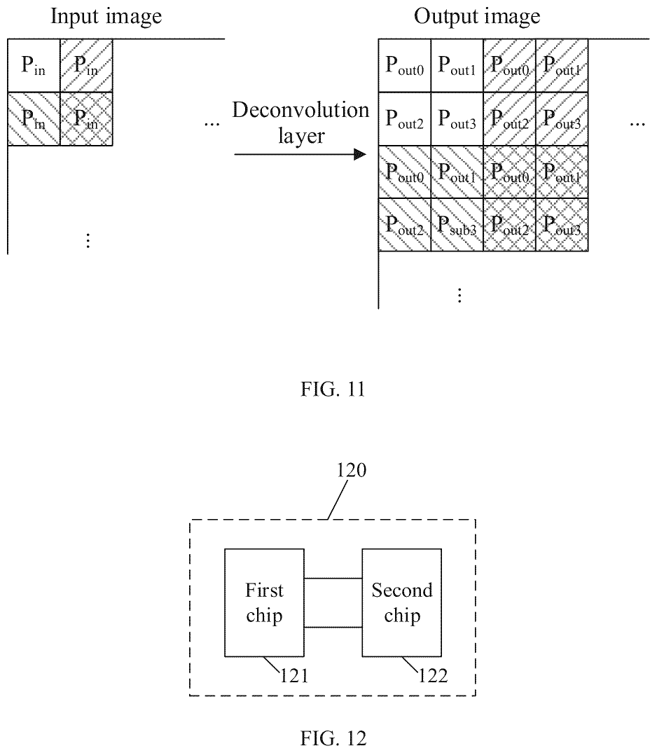

Finally, the arrangement order of pixels of the output image is as shown in FIG. 11. Each input pixel yields four output pixels through the operation of the deconvolution layer, thereby enlarging the size of the input image.

In this way, by having the calculation of the neural network model parameter part in the deconvolution layer completed by software control through the first chip, the calculation of the second chip is simplified from 2×2 convolution to 1×1 dot product, reducing the computational load to ¼ of the original, thereby reducing the power consumption of the second chip. Additionally, the addition operation of the first data and the second data can be completed through the existing second chip, without requiring new hardware logic. This also avoids the subtraction operation caused by the zero-point offset processing in the related art, eliminating the need for numerous subtractors and registers, thereby reducing the hardware area and power consumption of the second chip.

In the image processing method provided in the embodiments of this application, in the operation process of the deconvolution layer, a pixel value of an output pixel can be calculated based merely on the pixels in the input image and the convolution kernel, without requiring zero-point offset processing on each pixel of the input image throughout the operation process. This eliminates the need for numerous subtractors and registers, thereby reducing the occupied area and power consumption of hardware.

The foregoing method embodiments or various possible implementations in the method embodiments may be executed individually or may be executed in combination in the case of no conflict, which may be determined according to actual use requirements, and is not limited in the embodiments of this application.

FIG. 12 is a schematic diagram of an image processing system according to an embodiment of this application. As shown in FIG. 12, the image processing system 120 provided in the embodiment of this application may include: a first chip 121 and a second chip 122 that are different from each other, where the second chip 122 is a chip dedicated to computation of a neural network model.

The first chip 121 is configured to calculate first data based on at least one padding pixel in an input image, a coefficient in one convolution kernel and in one-to-one correspondence with the at least one padding pixel, and an output bias corresponding to the one convolution kernel; where the input image is an input image of a deconvolution layer in the neural network model. The second chip 122 is configured to calculate second data based on at least one non-padding pixel in the input image and a coefficient in the one convolution kernel and in one-to-one correspondence with the at least one non-padding pixel. The second chip 122 is further configured to calculate a pixel value of one output pixel based on the first data and the second data.

In a possible implementation, the first chip 121 may be configured to multiply a pixel value of each padding pixel in the at least one padding pixel by a corresponding coefficient in the one convolution kernel to obtain at least one piece of third data that is equal in quantity to the at least one padding pixel; and add a sum of the at least one piece of third data to the output bias to obtain the first data.

In a possible implementation, the second chip 122 is configured to multiply a pixel value of each non-padding pixel in the at least one non-padding pixel by a corresponding coefficient in the one convolution kernel to obtain at least one piece of fourth data that is equal in quantity to the at least one non-padding pixel; and add up the at least one piece of fourth data to obtain the second data.

In a possible implementation, the second chip 122 may be configured to add up the first data and the second data to obtain the pixel value of the one output pixel.

In the image processing system provided in the embodiments of this application, on the one hand, some of the operations in each convolution operation of the deconvolution layer can be assigned to be processed by the first chip other than the second chip dedicated to neural network model computation, thereby reducing the power consumption of the second chip. On the other hand, throughout the operation process of the deconvolution layer, it is no longer necessary to perform zero-point offset processing on each pixel of the input image, eliminating the need for numerous subtractors and registers, thereby reducing the hardware area of the second chip. The image processing system provided in the embodiments of this application can implement the processes implemented by the foregoing method embodiments, with the same technical effects achieved. To avoid repetition, details are not described herein again.

The image processing method provided in the embodiments of this application may be performed by an image processing apparatus. In the embodiments of this application, the image processing apparatus performing the image processing method is used as an example to illustrate the image processing apparatus according to an embodiment of this application.

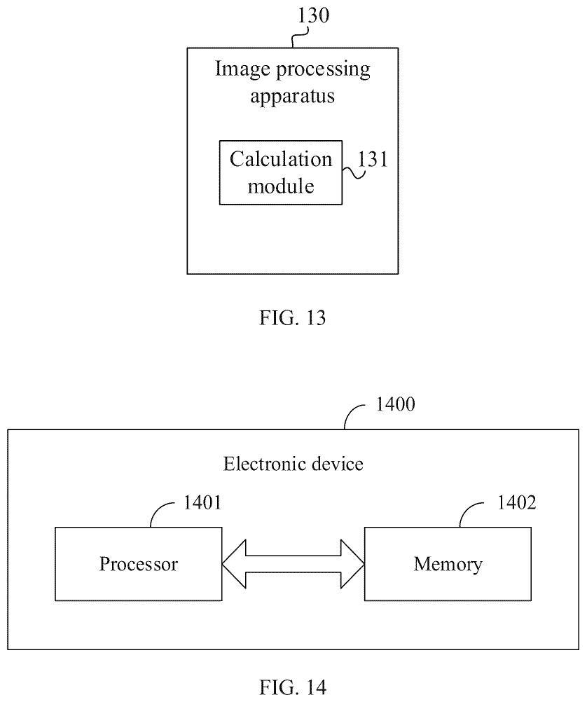

As shown in FIG. 13, an embodiment of this application provides an image processing apparatus 130. The image processing apparatus 130 may include a calculation module 131.

The calculation module 131 may be configured to calculate first data based on at least one padding pixel in an input image, a coefficient in one convolution kernel and in one-to-one correspondence with the at least one padding pixel, and an output bias corresponding to the one convolution kernel, where the input image is an input image of a deconvolution layer in a neural network model. The calculation module 131 may be further configured to calculate second data based on at least one non-padding pixel in the input image and a coefficient in the one convolution kernel and in one-to-one correspondence with the at least one non-padding pixel. The calculation module 131 may be further configured to calculate a pixel value of one output pixel based on the first data and the second data.

In a possible implementation, the calculation module 131 may be configured to multiply a pixel value of each padding pixel in the at least one padding pixel by a corresponding coefficient in the one convolution kernel to obtain at least one piece of third data that is equal in quantity to the at least one padding pixel; and add a sum of the at least one piece of third data to the output bias to obtain the first data.

In a possible implementation, the calculation module 131 may be configured to multiply a pixel value of each non-padding pixel in the at least one non-padding pixel by a corresponding coefficient in the one convolution kernel to obtain at least one piece of fourth data that is equal in quantity to the at least one non-padding pixel; and add up the at least one piece of fourth data to obtain the second data.

In a possible implementation, the calculation module 131 may be configured to add up the first data and the second data to obtain the pixel value of the one output pixel.

In the image processing apparatus according to the embodiments of this application, in the operation process of the deconvolution layer, a pixel value of an output pixel can be calculated based merely on the pixels in the input image and the convolution kernel, without requiring zero-point offset processing on each pixel of the input image throughout the operation process. This eliminates the need for numerous subtractors and registers, thereby reducing the occupied area and power consumption of the customized ASIC chip.

The image processing apparatus in the embodiments of this application may be an electronic device, or may be a component in an electronic device, such as an integrated circuit or a chip. The electronic device may be a terminal, or may be a device other than a terminal. For example, the electronic device may be a mobile phone, a tablet computer, a notebook computer, a palm computer, an in-vehicle electronic device, a Mobile Internet Device (MID), an Augmented Reality (AR)/Virtual Reality (VR) device, a robot, a wearable device, an Ultra-Mobile Personal Computer (UMPC), a netbook, a Personal Digital Assistant (PDA), or the like; or may be a server, a Network Attached Storage (NAS), a Personal Computer (PC), a Television (TV), an automated teller machine, a self-service machine, or the like, which is not limited in the embodiments of this application.

The image processing apparatus in the embodiments of this application may be an apparatus having an operating system. The operating system may be an Android operating system, an iOS operating system, or other possible operating systems, which is not limited in the embodiments of this application.

The image processing apparatus provided in the embodiments of this application can implement the processes implemented by the foregoing method embodiments, with the same technical effects achieved. To avoid repetition, details are not described herein again.

As shown in FIG. 14, an embodiment of this application further provides an electronic device 1400, including a processor 1401 and a memory 1402. The memory 1402 stores a program or instructions capable of running on the processor 1401. When the program or instructions are executed by the processor 1401, the steps of the foregoing image processing method embodiments can be implemented, with the same technical effects achieved. To avoid repetition, details are not described herein again.

It should be noted that the electronic device in the embodiments of this application includes a mobile electronic device and a non-mobile electronic device.

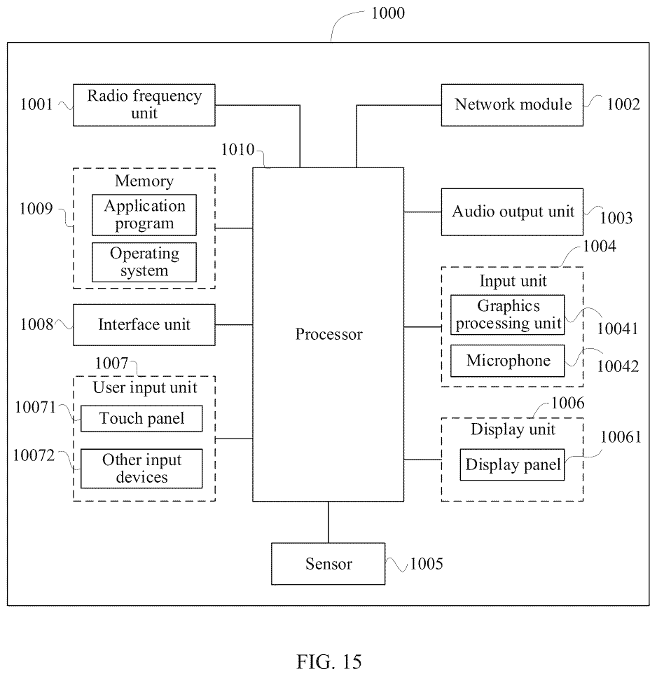

FIG. 15 is a schematic diagram of a hardware structure of an electronic device implementing the embodiments of this application.

As shown in FIG. 15, the electronic device 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

Those skilled in the art can understand that the electronic device 1000 may further include a power supply (such as a battery) for supplying power to various components, and the power supply may be logically connected to the processor 1010 through a power management system, to implement functions such as charging management, discharging management, and power consumption management through the power management system. The structure of the electronic device shown in FIG. 15 does not constitute a limitation on the electronic device, and the electronic device may include more or fewer components than shown in the figures, or combine some components, or have a different component arrangement, which are not described herein.

The processor 1010 may be configured to calculate first data based on at least one padding pixel in an input image, a coefficient in one convolution kernel and in one-to-one correspondence with the at least one padding pixel, and an output bias corresponding to the one convolution kernel, where the input image is an input image of a deconvolution layer in a neural network model; calculate second data based on at least one non-padding pixel in the input image and a coefficient in the one convolution kernel and in one-to-one correspondence with the at least one non-padding pixel; and calculate a pixel value of one output pixel based on the first data and the second data.

In a possible implementation, the processor 1010 may be configured to multiply a pixel value of each padding pixel in the at least one padding pixel by a corresponding coefficient in the one convolution kernel to obtain at least one piece of third data that is equal in quantity to the at least one padding pixel; and add a sum of the at least one piece of third data to the output bias to obtain the first data.

In a possible implementation, the processor 1010 may be configured to multiply a pixel value of each non-padding pixel in the at least one non-padding pixel by a corresponding coefficient in the one convolution kernel to obtain at least one piece of fourth data that is equal in quantity to the at least one non-padding pixel; and add up the at least one piece of fourth data to obtain the second data.

In a possible implementation, the processor 1010 is configured to add up the first data and the second data to obtain the pixel value of the one output pixel.

In the electronic device according to the embodiments of this application, in the operation process of the deconvolution layer, a pixel value of an output pixel can be calculated based merely on the pixels in the input image and the convolution kernel, without requiring zero-point offset processing on each pixel of the input image throughout the operation process. This eliminates the need for numerous subtractors and registers, thereby reducing the occupied area and power consumption of the customized ASIC chip.

It should be understood that, in the embodiments of this application, the input unit 1004 may include a Graphics Processing Unit (GPU) 10041 and a microphone 10042. The graphics processing unit 10041 processes image data of a still picture or video obtained by an image capture apparatus (such as a camera) in a video capture mode or an image capture mode. The display unit 1006 may include a display panel 10061, and the display panel 10061 may be configured in the form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, function keys (such as a volume control key and a power on/off key), a trackball, a mouse, and a joystick. Details are not described herein.

The memory 1009 may be configured to store software programs and various data. The memory 1009 may mainly include a first storage area for storing programs or instructions and a second storage area for storing data. The first storage area may store an operating system, an application program or instructions required by at least one function (such as a sound play function or an image play function), and the like. In addition, the memory 1009 may include a volatile memory or a non-volatile memory, or the memory 1009 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), or a Direct Rambus RAM (DRRAM). The memory 1009 in the embodiment of this application includes but is not limited to these and any other suitable types of memory.

The processor 1010 may include one or more processing units. In some embodiments, an application processor and a modem processor are integrated in the processor 1010, where the application processor mainly processes operations related to an operating system, a user interface, an application program, and the like, and the modem processor, such as a baseband processor, mainly processes wireless communication signals. It can be understood that the modem processor may be not integrated in the processor 1010.

An embodiment of this application further provides a readable storage medium. The readable storage medium stores a program or instructions, and when the program or instructions are executed by a processor, the processes of the foregoing image processing method embodiments are implemented, with the same technical effects achieved. To avoid repetition, details are not described herein again.

The processor is the processor in the electronic device in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, where the communication interface is coupled to the processor, and the processor is configured to run a program or instructions to implement the processes of the foregoing image processing method embodiments, with the same technical effects achieved. To avoid repetition, details are not described herein again.

It should be understood that the chip mentioned in the embodiments of this application may also be referred to as a system-on-chip, a system chip, a system-on-a-chip, a system on a chip, or the like.

An embodiment of this application provides a computer program product. The program product is stored in a storage medium, and the program product is executed by at least one processor to implement the processes of the foregoing image processing method embodiments, with the same technical effects achieved. To avoid repetition, details are not described herein again.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiments may be implemented by software with a necessary general hardware platform. The method in the foregoing embodiments may also be implemented by hardware. In some embodiments, the technical solutions of this application entirely or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. An image processing method, comprising:
calculating first data based on at least one padding pixel in an input image, a coefficient in one convolution kernel and in one-to-one correspondence with the at least one padding pixel, and an output bias corresponding to the one convolution kernel, wherein the input image is an input image of a deconvolution layer in a neural network model;
calculating second data based on at least one non-padding pixel in the input image and a coefficient in the one convolution kernel and in one-to-one correspondence with the at least one non-padding pixel; and
calculating a pixel value of one output pixel based on the first data and the second data.

2. The image processing method according to claim 1, wherein the calculating first data based on at least one padding pixel in an input image, a coefficient in one convolution kernel and in one-to-one correspondence with the at least one padding pixel, and an output bias corresponding to the one convolution kernel comprises:
multiplying a pixel value of each padding pixel in the at least one padding pixel by a corresponding coefficient in the one convolution kernel to obtain at least one piece of third data that is equal in quantity to the at least one padding pixel; and
adding a sum of the at least one piece of third data to the output bias to obtain the first data.

3. The image processing method according to claim 1, wherein the calculating second data based on at least one non-padding pixel in the input image and a coefficient in the one convolution kernel and in one-to-one correspondence with the at least one non-padding pixel comprises:
multiplying a pixel value of each non-padding pixel in the at least one non-padding pixel by a corresponding coefficient in the one convolution kernel to obtain at least one piece of fourth data that is equal in quantity to the at least one non-padding pixel; and
adding up the at least one piece of fourth data to obtain the second data.

4. The image processing method according to claim 1, wherein the calculating a pixel value of one output pixel based on the first data and the second data comprises:
adding up the first data and the second data to obtain the pixel value of the one output pixel.

5. The image processing method according to claim 2, wherein the calculating a pixel value of one output pixel based on the first data and the second data comprises:
adding up the first data and the second data to obtain the pixel value of the one output pixel.

6. The image processing method according to claim 3, wherein the calculating a pixel value of one output pixel based on the first data and the second data comprises:
adding up the first data and the second data to obtain the pixel value of the one output pixel.

7. An image processing system, comprising: a first chip; and a second chip, wherein the first chip and the second chip are different from each other, and the second chip is a chip dedicated to computation of a neural network model,
wherein:
the first chip is configured to calculate first data based on at least one padding pixel in an input image, a coefficient in one convolution kernel and in one-to-one correspondence with the at least one padding pixel, and an output bias corresponding to the one convolution kernel, wherein the input image is an input image of a deconvolution layer in the neural network model,
the second chip is configured to calculate second data based on at least one non-padding pixel in the input image and a coefficient in the one convolution kernel and in one-to-one correspondence with the at least one non-padding pixel, and
the second chip is further configured to calculate a pixel value of one output pixel based on the first data and the second data.

8. The image processing system according to claim 7, wherein
the first chip is configured to:
multiply a pixel value of each padding pixel in the at least one padding pixel by a corresponding coefficient in the one convolution kernel to obtain at least one piece of third data that is equal in quantity to the at least one padding pixel, and
add a sum of the at least one piece of third data to the output bias to obtain the first data.

9. The image processing system according to claim 7, wherein
the second chip is configured to:
multiply a pixel value of each non-padding pixel in the at least one non-padding pixel by a corresponding coefficient in the one convolution kernel to obtain at least one piece of fourth data that is equal in quantity to the at least one non-padding pixel, and
add up the at least one piece of fourth data to obtain the second data.

10. The image processing system according to claim 7, wherein
the second chip is configured to add up the first data and the second data to obtain the pixel value of the one output pixel.

11. The image processing system according to claim 8, wherein
the second chip is configured to add up the first data and the second data to obtain the pixel value of the one output pixel.

12. The image processing system according to claim 9, wherein
the second chip is configured to add up the first data and the second data to obtain the pixel value of the one output pixel.

13. An electronic device, comprising: a processor; and a memory storing a program or instructions, wherein the program or instructions, when executed by the processor, causes the processor to perform operations comprising:
calculating first data based on at least one padding pixel in an input image, a coefficient in one convolution kernel and in one-to-one correspondence with the at least one padding pixel, and an output bias corresponding to the one convolution kernel, wherein the input image is an input image of a deconvolution layer in a neural network model,
calculating second data based on at least one non-padding pixel in the input image and a coefficient in the one convolution kernel and in one-to-one correspondence with the at least one non-padding pixel, and
calculating a pixel value of one output pixel based on the first data and the second data.

14. The electronic device according to claim 13, wherein the calculating first data based on at least one padding pixel in an input image, a coefficient in one convolution kernel and in one-to-one correspondence with the at least one padding pixel, and an output bias corresponding to the one convolution kernel comprises:
multiplying a pixel value of each padding pixel in the at least one padding pixel by a corresponding coefficient in the one convolution kernel to obtain at least one piece of third data that is equal in quantity to the at least one padding pixel; and
adding a sum of the at least one piece of third data to the output bias to obtain the first data.

15. The electronic device according to claim 13, wherein the calculating second data based on at least one non-padding pixel in the input image and a coefficient in the one convolution kernel and in one-to-one correspondence with the at least one non-padding pixel comprises:
multiplying a pixel value of each non-padding pixel in the at least one non-padding pixel by a corresponding coefficient in the one convolution kernel to obtain at least one piece of fourth data that is equal in quantity to the at least one non-padding pixel; and
adding up the at least one piece of fourth data to obtain the second data.

16. The electronic device according to claim 13, wherein the calculating a pixel value of one output pixel based on the first data and the second data comprises:
adding up the first data and the second data to obtain the pixel value of the one output pixel.

17. The electronic device according to claim 14, wherein the calculating a pixel value of one output pixel based on the first data and the second data comprises:
adding up the first data and the second data to obtain the pixel value of the one output pixel.

18. The electronic device according to claim 15, wherein the calculating a pixel value of one output pixel based on the first data and the second data comprises:
adding up the first data and the second data to obtain the pixel value of the one output pixel.

19. A non-transitory computer-readable storage medium storing a program or instructions that, when executed by a processor, causes the processor to perform the image processing method according to claim 1.

20. A chip, comprising: a processor; and a communication interface coupled to the processor, wherein the processor is configured to execute a program or instructions to perform the image processing method according to claim 1.
